(19) United States
(12) Patent Application Publication
(10) Pub. No.: US 2026/0245443 A1
(43) Pub. Date: Aug. 20, 2026

(54) FALL DETECTION SYSTEM AND FALL DETECTION METHOD

(71) Applicant: National Yang Ming Chiao Tung University, Hsinchu City (TW)

(72) Inventors: Ta-Sung LEE, Hsinchu City (TW); Ming-Chun LEE, Hsinchu County (TW); Hsu-Chen KAO, New Taipei City (TW); Chia-Hsing YANG, Taichung City (TW)

(21) Appl. No.: 19/239,975

(22) Filed: Jun. 17, 2025

(30) Foreign Application Priority Data
Feb. 17, 2025 (TW) 114105806

(51) Int. Cl. G08B 21/04; G01S 17/89

(52) U.S. Cl. CPC G08B 21/043; G01S 17/89; G08B 21/0423; G08B 21/0438

(57) ABSTRACT

A fall detection system includes a sensor which configured to obtain all point cloud data of a sensing environment, a target tracking module which configured to identify target point cloud data of a target object, a time series feature extraction module which configured to process the target point cloud data and output a time series feature matrix, a fall action classifier which configured to receive the time series feature matrix and output a fall action classification result, a target finite-state machine module which configured to receive the fall action classification result and calculate a state duration of a target finite-state machine corresponding to the target object, an object recognition classifier which configured to receive the time series feature matrix and output an object recognition result, and an alarm module which configured to output a warning message according to the state duration and the object recognition result.

### RELATED APPLICATIONS

This application claims priority to Taiwan Application Serial Number 114105806, filed on Feb. 17, 2025, which is herein incorporated by reference.

### BACKGROUND

### Technical Field

The present disclosure relates to a detection system and a detection method, and more particularly to a fall detection system and a fall detection method.

### Description of Related Art

Existing technologies for fall detection utilizing radar are mainly based on deep learning methods. However, most deep learning methods only rely on the output of a fall action classifier as the basis for a fall alarm, and do not distinguish stage states of fall action of a target object, and there is no deep learning method that utilizes a finite-state machine to track the fall process and lying down states of the target object after the target object falling. Therefore, the fall detection system implemented by the prior art is prone to generate false alarms due to a single misclassification, thereby reducing the detection accuracy. In addition, the fall detection system implemented with existing technologies is unable to determine whether the target object gets up after lying down to the ground, and is also unable to calculate the duration of the target object lying down to the ground. Therefore, it is difficult to accurately control the real-time condition of the target object.

### SUMMARY

The object of the present disclosure is to provide a fall detection system and a fall detection method, which process point cloud data of a target person to be tested through a lightweight time series target feature extraction technique and output a time series feature matrix, and then processes the time series feature matrix through a fall action classifier established based on a deep learning model and outputs a fall action classification result, which is utilized to determine the current state of the target person and calculate the state duration of a target finite-state machine corresponding to the target person, and then processes the time series feature matrix through an object recognition classifier established based on a deep learning model and outputs an object recognition result. Finally, the state duration of the target finite-state machine and the object recognition result output by the object recognition classifier are both utilized as a basis for determining whether the fall detection system outputs a warning message.

One aspect of the present disclosure relates to a fall detection system, which includes a sensor, a target tracking module, a time series feature extraction module, a fall action classifier, a target finite-state machine module, an object recognition classifier, and an alarm module. The sensor is configured to obtain at least one point cloud data of a sensing environment. The target tracking module is configured to identify at least one target point cloud data of a target object from the at least one point cloud data. The time series feature extraction module is configured to process the at least one target point cloud data utilizing a lightweight time series target feature extraction technique and output a time series feature matrix. The fall action classifier is configured to receive the time series feature matrix and output a fall action classification result. The target finite-state machine module is configured to receive the fall action classification result and calculate a state duration of a target finite-state machine corresponding to the target object. The object recognition classifier is configured to receive the time series feature matrix and output an object recognition result. The alarm module is configured to output a warning message according to the state duration and the object recognition result.

In accordance with one or more embodiments of the present disclosure, the time series feature extraction module is further configured to utilize the lightweight time series target feature extraction technique to extract a 12-dimensional time series feature of the target object in three-dimensional space from the target point cloud data.

In accordance with one or more embodiments of the present disclosure, the 12-dimensional time series feature comprises at least one of a position, a distance, an angle, a signal-to-noise ratio (SNR), and a speed.

In accordance with one or more embodiments of the present disclosure, the time series feature matrix is a 12-dimensional time series feature matrix, and the time series feature extraction module is further configured to generate and compress the 12-dimensional time series features into the 12-dimensional time series feature matrix.

In accordance with one or more embodiments of the present disclosure, the fall action classifier is established based on a deep learning model.

In accordance with one or more embodiments of the present disclosure, the target finite-state machine module is further configured to define three states of the target finite-state machine, namely a normal activity state, a fall state and a lying down state, respectively, and calculate the state duration of the target finite-state machine corresponding to the target object based on the normal activity state, the fall state and the lying down state.

In accordance with one or more embodiments of the present disclosure, the target finite-state machine module is further configured to calculate a target get-up height of the target object utilizing an adaptive get-up height threshold algorithm.

In accordance with one or more embodiments of the present disclosure, the fall action classification result is a normal activity action or a fall action, and wherein the object recognition result is a human fall or a non-human fall.

In accordance with one or more embodiments of the present disclosure, the alarm module outputs the warning message in response to the state duration being greater than a preset time threshold and the object recognition result is the human fall.

Another aspect of the present disclosure relates to a fall detection method, which includes utilizing a sensor to obtain at least one point cloud data of a sensing environment; utilizing a target tracking module to identify at least one target point cloud data of a target object from the at least one point cloud data; utilizing a time series feature extraction module to process the at least one target point cloud data through a lightweight time series target feature extraction technique and output a time series feature matrix; utilizing a fall action classifier to receive the time series feature matrix and output a fall action classification result; utilizing a target finite-state machine module to receive the fall action classification result and calculate a state duration of a target finite-state machine corresponding to the target object; utilizing an object recognition classifier to receive the time series feature matrix and output an object recognition result; and utilizing an alarm module to output a warning message according to the state duration and the object recognition result.

In accordance with one or more embodiments of the present disclosure, the time series feature extraction module is further configured to utilize the lightweight time series target feature extraction technique to extract a 12-dimensional time series feature of the target object in three-dimensional space from the target point cloud data.

In accordance with one or more embodiments of the present disclosure, the 12-dimensional time series feature comprises at least one of a position, a distance, an angle, a signal-to-noise ratio (SNR), and a speed.

In accordance with one or more embodiments of the present disclosure, the time series feature matrix is a 12-dimensional time series feature matrix, and the time series feature extraction module is further configured to generate and compress the 12-dimensional time series features into the 12-dimensional time series feature matrix.

In accordance with one or more embodiments of the present disclosure, the fall action classifier is established based on a deep learning model.

In accordance with one or more embodiments of the present disclosure, the target finite-state machine module is further configured to define three states of the target finite-state machine, namely a normal activity state, a fall state and a lying down state, respectively, and calculate the state duration of the target finite-state machine corresponding to the target object based on the normal activity state, the fall state and the lying down state.

In accordance with one or more embodiments of the present disclosure, the target finite-state machine module is further configured to calculate a target get-up height of the target object utilizing an adaptive get-up height threshold algorithm.

In accordance with one or more embodiments of the present disclosure, the fall action classification result is a normal activity action or a fall action, and wherein the object recognition result is a human fall or a non-human fall.

In accordance with one or more embodiments of the present disclosure, the alarm module outputs the warning message in response to the state duration being greater than a preset time threshold and the object recognition result is the human fall.

### BRIEF DESCRIPTION OF THE DRAWINGS

This disclosure can be more fully understood by reading the following detailed description of the embodiments, with reference made to the accompanying drawings as follows:

FIG. 1 is a functional block diagram of a fall detection system in accordance with some embodiments of the present disclosure.

FIG. 2 is a schematic diagram of a finite-state machine in accordance with some embodiments of the present disclosure.

FIG. 3 is a flowchart of a fall detection method in accordance with some embodiments of the present disclosure.

### DETAILED DESCRIPTION

Reference will now be made in detail to the present embodiments of this disclosure, examples of which are illustrated in the accompanying drawings. Wherever possible, the same reference numbers are utilized in the drawings and the description to refer to the same or like parts. The term “couple” and its conjugated forms means to complete any type of required junction, including electrical, mechanical, or fluid, to form a singular object from two or more previously non-joined objects.

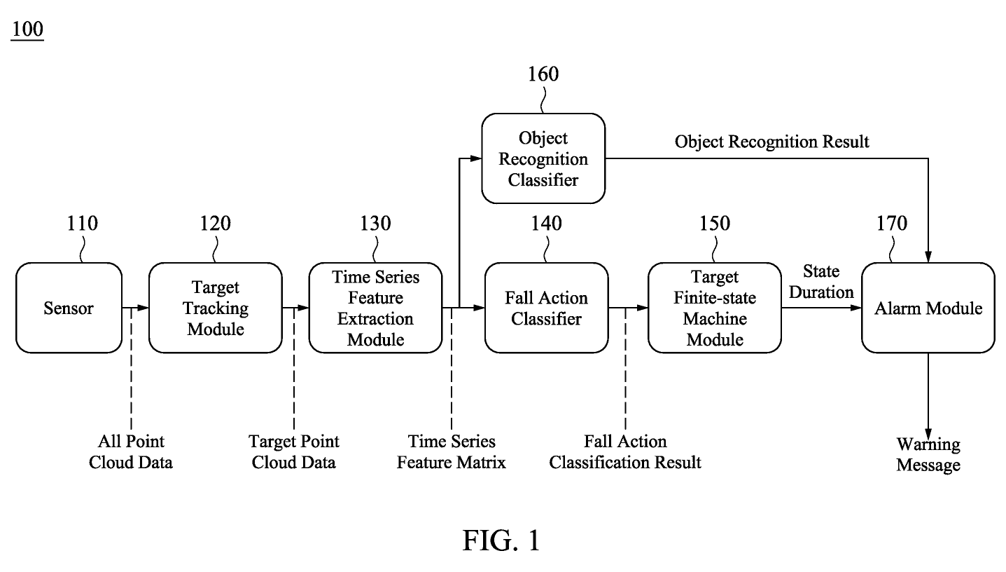

FIG. 1 is a functional block diagram of a fall detection system 100 in accordance with some embodiments of the present disclosure. The fall detection system 100 includes a sensor 110, a target tracking module 120, a time series feature extraction module 130, a fall action classifier 140, a target finite-state machine module 150, an object recognition classifier 160, and an alarm module 170. The sensor 110 is configured to obtain at least one point cloud data of a sensing environment. The target tracking module 120 is configured to identify at least one target point cloud data of a target object from the at least one point cloud data. The time series feature extraction module 130 is configured to process the at least one target point cloud data utilizing a lightweight time series target feature extraction technique and output a time series feature matrix. The fall action classifier 140 is configured to receive the time series feature matrix and output a fall action classification result. The target finite-state machine module 150 is configured to receive the fall action classification result and calculate a state duration of a target finite-state machine corresponding to the target object. The object recognition classifier 160 is configured to receive the time series feature matrix and output an object recognition result. The alarm module 170 is configured to output a warning message according to the state duration and the object recognition result. In one embodiment of the present disclosure, the fall detection system 100 further includes a memory (not shown in FIG. 1) and a processor (not shown in FIG. 1), in which the memory is configured to store one or more instructions for implementing the operation of multiple modules (including but not limited to the sensor 110, the target tracking module 120, the time series feature extraction module 130, the fall action classifier 140, the target finite-state machine module 150, the object recognition classifier 160 and the alarm module 170). The memory may be a random access memory (RAM), static random-access memory (SRAM), a flash memory, a solid state drive (SSD), other similar components, or a combination of the above components, but not limited to this. The processor is configured to execute these instructions stored in the memory to complete the functions of each module. The processor may be a central processing unit (CPU), a graphics processing unit (GPU), a microcontroller unit (MCU), a microprocessor, a system-on-chip (SoC), a digital signal processor (DSP), an application-specific integrated circuit (ASIC), a programmable logic controller (PLC), or a combination of the above components, but not limited to this.

In one embodiment of the present disclosure, the sensor 110 of the fall detection system 100 may optionally utilize a radar to obtain point cloud data in a sensing environment, but the present disclosure is not limited to utilizing the radar to implement the function of obtaining point cloud data. Further, the radar utilized in the fall detection system 100 may be a millimeter wave radar, which operating in a millimeter wave band, emitting millimeter waves through an antenna and receiving signals reflected from a target object/obstacle to calculate the speed, the distance, and the angle relative to the target object.

After receiving all point cloud data in the sensing environment obtained by the sensor 110 (such as a millimeter wave radar), the target tracking module 120 then identifies target point cloud data of the target object from all point cloud data. In specific, the target tracking module 120 processes all obtained radar point cloud data through a clustering algorithm and identifies the target point cloud data belonging to the target object from all obtained radar point cloud data.

In specific, the lightweight time series target feature extraction technique is utilized to process the target point cloud data through the estimation process of calculating an average value, calculating a standard deviation, taking maximum values and minimum values, so as to give the target object 12 features including a position (such as X-coordinate, Y-coordinate, Z-coordinate), a signal-to-noise ratio (SNR), a distance, a horizontal angle, a pitch angle, a radial velocity, a radial velocity standard deviation, a maximum radial velocity, a minimum radial velocity, a maximum and minimum radial velocity difference, etc., that is, extracting the 12-dimensional time series features of the target object in three-dimensional space from the target point cloud data.

These extracted features are then input into a buffer that can store 25 frames of target features to form a 12-dimensional time series feature matrix with 25 rows and 12 columns, and then calculate the average value in the time domain with a specific number of frames as a unit to achieve the effect of compressing the time series feature matrix.

In one embodiment of the present disclosure, if the average value is calculated in a unit of 5 frames in the time domain, a lightweight 12-dimensional time series feature matrix with 5 columns and 12 rows may be output, which may improve the classification efficiency of the classifier required for subsequent processes, and is suitable for calculation on a microcomputer. It should also be noted that, in this embodiment, only the example of calculating the average value in units of every 5 frames in the time domain is used for explanation, but the present invention is not limited to the selected number of frames. That is, in other embodiments of the present disclosure, if the average value is calculated in a unit of other numbers of frames in the time domain, then a lightweight 12-dimensional time series feature matrix with other numbers of rows and 12 columns may be output, which may also achieve the effect of compressing the time series feature matrix.

After receiving the lightweight time series feature matrix from the time series feature extraction module 130, the fall action classifier 140 then outputs a fall action classification result. In specific, the fall action classifier 140 is established based on a deep learning model. In one embodiment of the present disclosure, the fall action classifier 140 may be established based on, for example, a long short-term memory (LSTM) deep learning model. The LSTM deep learning model architecture includes a 10-unit LSTM layer and a dropout layer for classifying the time series feature matrix input to the model, so as to determine whether the fall action classification result of the target object is "normal activity action" or "fall action". The fall action classification result of the target object may be considered as the output of the fall action classifier 140 established based on the deep learning model. It should be noted that the fall action classification result output by the fall action classifier 140 may then be received and processed by the target finite-state machine module 150, and may not immediately trigger an alarm when the fall action classification result of the target object is classified as a fall action, thereby significantly reducing the probability of false alarms. It should also be noted that in this embodiment, although only the LSTM deep learning model architecture is utilized to establish the fall action classifier 140 as an example, the present disclosure does not limit the deep learning model utilized to establish the fall action classifier 140. That is, in other embodiments of the present disclosure, the fall action classifier 140 may be implemented utilizing other deep learning model architectures different from the LSTM deep learning model architecture.

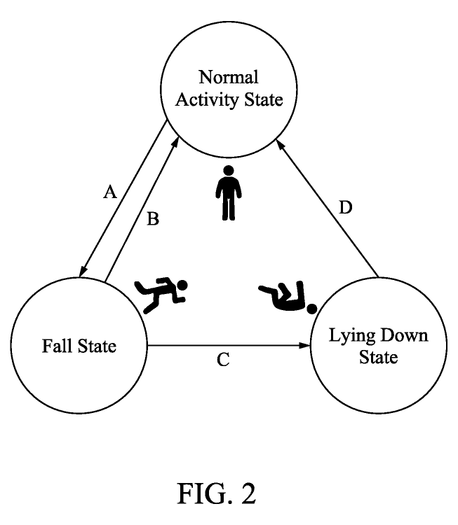

After receiving the fall action classification result from the fall action classifier 140, the target finite-state machine module 150 then calculates a state duration of the target finite-state machine corresponding to the target object. In specific, the complete fall action of the target object may be roughly divided into three stages: an initial stable stage, a fall stage and a lying down stage. These three stages may respectively correspond to the three states of the target finite-state machine of the target object: the normal activity state, the fall state and the lying down state, which may be referred to the schematic diagram of the target finite-state machine shown in FIG. 2. In the initial stage of fall detection, the target object may directly enter the normal activity state, and then determine whether the target object is transferred from the normal activity state to the fall state according to the fall action classification result output by the fall action classifier 140.

Further, if the fall action classification result output by the fall action classifier 140 is "falling action", and the target object has also transferred from the normal activity state to the fall state (such as path A shown in FIG. 2), then the target finite-state machine module 150 may observe whether the fall action classifier 140 continues to output the fall action classification result of "fall action" (that is, whether the target finite-state machine module 150 continues to receive the fall action category frames), and set a threshold number of the continuous fall action category frames to further confirm which state the target object is in the target finite-state machine.

In one embodiment of the present disclosure, when the number of the fall action category frames continuously received by the target finite-state machine module 150 is less than the set threshold number of the continuous fall action category frames, and then the next frame received is not a fall action category frame, the target finite-state machine module 150 returns the state of the target object to the normal activity state, such as path B shown in FIG. 2.

In one embodiment of the present disclosure, when the number of the fall action category frames continuously received by the target finite-state machine module 150 is greater than or equal to the set threshold number of the continuous fall action category frames, and then the next frame received is not a fall action category frame, the target finite state machine module 150 transfers the state of the target object from the fall state to the lying down state, such as path C shown in FIG. 2.

In one embodiment of the present disclosure, when the state of the target object is transferred from the fall state to the lying down state, the target finite-state machine module 150 may utilize an adaptive get-up height threshold algorithm to calculate a target get-up height of the target object. In detail, the adaptive get-up height threshold algorithm sets a get-up height threshold by adding and averaging the initial fall height and the final fall height of the target object, and considering a preset get-up height constant. In one embodiment of the present disclosure, if the target get-up height of the frame currently received by the target finite-state machine module 150 is less than the get-up height threshold, the state of the target object is maintained in the fall state; on the other hand, if the target get-up height of the frame currently received by the target finite-state machine module 150 is greater than or equal to the get-up height threshold, the number of get-up times of the target object is calculated plus one. When the number of get-up times of the target object exceeds a preset threshold number of get-up times, the target finite-state machine module 150 transfers the state of the target object from the lying down state back to the normal activity state, such as path D shown in FIG. 2.

It should be noted that both situation of the target finite-state machine module 150 transferring the state of the target object from the normal activity state to the fall state or transferring the state of the target object from the fall state to the lying down state, the target finite-state machine module 150 calculates the state duration of fall state and the lying down state of the target object, respectively. That is, the state duration of fall state and the lying down state calculated by the target finite-state machine module 150 may be utilized as a reference for whether to trigger a fall alarm.

After receiving the lightweight time series feature matrix from the time series feature extraction module 130, the object recognition classifier 160 then outputs an object recognition result. In specific, the object recognition classifier 160 may also be established based on a deep learning model. In one embodiment of the present disclosure, the object recognition classifier 160 may be established based on, for example, a LSTM deep learning model. The LSTM deep learning model architecture includes a 4-unit LSTM layer and two batch normalization layers, which are utilized for classifying the time series feature matrix input to the model, so as to determine whether the object recognition result of the target object is "human fall" or "non-human fall". The object recognition classification result of the target object may be considered as the output of the object recognition classifier 160 established based on the deep learning model. It should also be noted that, in this embodiment, although only the LSTM deep learning model architecture is utilized to establish the object recognition classifier 160 as an example, the present disclosure does not limit the deep learning model utilized to establish the object recognition classifier 160. That is, in other embodiments of the present disclosure, the object recognition classifier 160 may be implemented utilizing other deep learning model architectures different from the LSTM deep learning model architecture.

The fall detection system 100 further includes an alarm module 170 for determining whether to output a warning message based on the state duration of the target object (such as the state duration of the fall state and the lying down state) calculated by the target finite-state machine module 150. In addition, the alarm module 170 also determines whether to output the warning message based on the object recognition result (such as the object recognition result of "human fall" or "non-human fall") output by the object recognition classifier 160, thereby filtering out false alarms generated by non-human target objects to improve the detection accuracy of the fall detection system 100. In one embodiment of the present disclosure, when the state duration calculated by the target finite-state machine module 150 is greater than a preset time threshold and the object recognition result output by the object recognition classifier 160 is “human fall”, the alarm module 170 outputs the warning message.

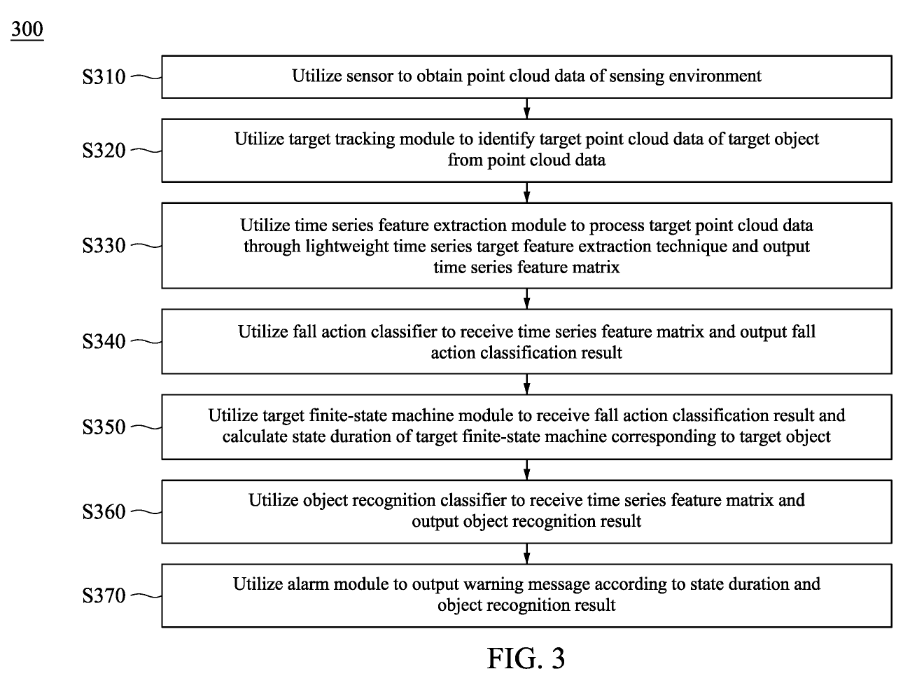

FIG. 3 is a flowchart of a fall detection method in accordance with some embodiments of the present disclosure. The fall detection method 300 includes Steps S310 to S370, which are described below.

Step S310: utilize a sensor to obtain at least one point cloud data of a sensing environment.

Step S320: utilize a target tracking module to identify at least one target point cloud data of a target object from the at least one point cloud data.

Step S330: utilize a time series feature extraction module to process the at least one target point cloud data through a lightweight time series target feature extraction technique and output a time series feature matrix.

Step S340: utilize a fall action classifier to receive the time series feature matrix and output a fall action classification result.

Step S350: utilize a target finite-state machine module to receive the fall action classification result and calculate a state duration of a target finite-state machine corresponding to the target object.

Step S360: utilize an object recognition classifier to receive the time series feature matrix and output an object recognition result.

Step S370: utilize an alarm module to output a warning message according to the state duration and the object recognition result.

The description of each step (including but not limited to Steps S310 to S370) in FIG. 3 may refer to the operation of each component in the fall detection system 100 shown in FIG. 1, and may not be described again here.

As can be seen from the above description, the fall detection system and the fall detection method of the present disclosure process point cloud data of a target person to be tested through a lightweight time series target feature extraction technique and output a time series feature matrix, and then processes the time series feature matrix through a fall action classifier established based on a deep learning model and outputs a fall action classification result, which is utilized to determine the current state of the target person and calculate the state duration of a target finite-state machine corresponding to the target person, and then processes the time series feature matrix through an object recognition classifier established based on a deep learning model and outputs an object recognition result. Finally, the state duration of the target finite-state machine and the object recognition result output by the object recognition classifier are both utilized as a basis for determining whether the fall detection system outputs a warning message.

It will be apparent to those skilled in the art that various modifications and variations can be made to the structure of the present disclosure without departing from the scope or spirit of this disclosure. In view of the foregoing, it is intended that the present disclosure cover modifications and variations of this disclosure provided they fall within the scope of the following claims.

What is claimed is:

1. A fall detection system, comprising:
a sensor configured to obtain at least one point cloud data of a sensing environment;
a target tracking module configured to identify at least one target point cloud data of a target object from the at least one point cloud data;
a time series feature extraction module configured to process the at least one target point cloud data utilizing a lightweight time series target feature extraction technique and output a time series feature matrix;
a fall action classifier configured to receive the time series feature matrix and output a fall action classification result;
a target finite-state machine module configured to receive the fall action classification result and calculate a state duration of a target finite-state machine corresponding to the target object;
an object recognition classifier configured to receive the time series feature matrix and output an object recognition result; and
an alarm module configured to output a warning message according to the state duration and the object recognition result.

2. The fall detection system of claim 1, wherein the time series feature extraction module is further configured to utilize the lightweight time series target feature extraction technique to extract a 12-dimensional time series feature of the target object in three-dimensional space from the target point cloud data.

3. The fall detection system of claim 2, wherein the 12-dimensional time series feature comprises at least one of a position, a distance, an angle, a signal-to-noise ratio (SNR), and a speed.

4. The fall detection system of claim 2, wherein the time series feature matrix is a 12-dimensional time series feature matrix, and the time series feature extraction module is further configured to generate and compress the 12-dimensional time series feature into the 12-dimensional time series feature matrix.

5. The fall detection system of claim 1, wherein the fall action classifier is established based on a deep learning model.

6. The fall detection system of claim 1, wherein the target finite-state machine module is further configured to define three states of the target finite-state machine, namely a normal activity state, a fall state and a lying down state, respectively, and calculate the state duration of the target finite-state machine corresponding to the target object based on the normal activity state, the fall state and the lying down state.

7. The fall detection system of claim 6, wherein the target finite-state machine module is further configured to calculate a target get-up height of the target object utilizing an adaptive get-up height threshold algorithm.

8. The fall detection system of claim 1, wherein the fall action classification result is a normal activity action or a fall action, and wherein the object recognition result is a human fall or a non-human fall.

9. The fall detection system of claim 8, wherein the alarm module outputs the warning message in response to the state duration being greater than a preset time threshold and the object recognition result is the human fall.

10. A fall detection method, comprising:
utilizing a sensor to obtain at least one point cloud data of a sensing environment;
utilizing a target tracking module to identify at least one target point cloud data of a target object from the at least one point cloud data;
utilizing a time series feature extraction module to process the at least one target point cloud data through a lightweight time series target feature extraction technique and output a time series feature matrix;
utilizing a fall action classifier to receive the time series feature matrix and output a fall action classification result;
utilizing a target finite-state machine module to receive the fall action classification result and calculate a state duration of a target finite-state machine corresponding to the target object;
utilizing an object recognition classifier to receive the time series feature matrix and output an object recognition result; and
utilizing an alarm module to output a warning message according to the state duration and the object recognition result.

11. The fall detection method of claim 10, wherein the time series feature extraction module is further configured to utilize the lightweight time series target feature extraction technique to extract a 12-dimensional time series feature of the target object in three-dimensional space from the target point cloud data.

12. The fall detection method of claim 11, wherein the12-dimensional time series feature comprises at least one of a position, a distance, an angle, a signal-to-noise ratio (SNR), and a speed.

13. The fall detection method of claim 11, wherein the time series feature matrix is a 12-dimensional time series feature matrix, and the time series feature extraction module is further configured to generate and compress the 12-dimensional time series feature into the 12-dimensional time series feature matrix.

14. The fall detection method of claim 10, wherein the fall action classifier is established based on a deep learning model.

15. The fall detection method of claim 10, wherein the target finite-state machine module is further configured to define three states of the target finite-state machine, namely a normal activity state, a fall state and a lying down state, respectively, and calculate the state duration of the target finite-state machine corresponding to the target object based on the normal activity state, the fall state and the lying down state.

16. The fall detection method of claim 15, wherein the target finite-state machine module is further configured to calculate a target get-up height of the target object utilizing an adaptive get-up height threshold algorithm.

17. The fall detection method of claim 10, wherein the fall action classification result is a normal activity action or a fall action, and wherein the object recognition result is a human fall or a non-human fall.

18. The fall detection method of claim 17, wherein the alarm module outputs the warning message in response to the state duration being greater than a preset time threshold and the object recognition result is the human fall.
